(19) United States
(12) Patent Application Publication
(10) Pub. No.: US 2008/0057930 A1
(43) Pub. Date: Mar. 6, 2008

(54) Electronic apparatus and wireless communication control method

(75) Inventor: Shinzo Matsubara, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/896,196

(22) Filed: Aug. 30, 2007

(30) Foreign Application Priority Data
Sep. 1, 2006 (JP) 2006-237958

(51) Int. Cl. H04M 3/00; H04B 1/38

(52) U.S. Cl. 455/418; 455/556.1

(57) ABSTRACT

According to one embodiment, an electronic apparatus executes wireless communication with use of any one of a plurality of wireless communication channels. The electronic apparatus includes a wireless communication module, a scan process control unit, and a device list sending unit. The scan process control unit transitions, when an application program that is executed by the electronic apparatus outputs a wireless device detection request in response to a user's request, the wireless communication module from the sleep state to the active state, and causes the wireless communication module to execute a scan process for detecting wireless devices, and transitions, when the scan process for all the plurality of wireless communication channels is terminated, the wireless communication module from the active state to the sleep state. The device list sending unit sends to the application program a device list indicating wireless devices detected by the scan process.

### CROSS-REFERENCE TO RELATED APPLICATIONS

This application is based upon and claims the benefit of priority from Japanese Patent Application No. 2006-237958, filed Sep. 1, 2006, the entire contents of which are incorporated herein by reference.

### BACKGROUND

1. Field

One embodiment of the invention relates to an electronic apparatus having a wireless communication function, and a wireless communication control method for use in the electronic apparatus.

2. Description of the Related Art

In general, portable electronic apparatuses, such as personal computers, personal digital assistants (PDA) and audio players, are required to reduce power consumption. In particular, in an electronic apparatus including a wireless communication module, such as a wireless LAN module, a relatively high power is consumed by the wireless communication module. It is thus necessary to reduce the power consumption of the wireless communication module.

Jpn. Pat. Appln. KOKAI Publication No. 2006-005577 discloses a portable terminal apparatus having a power-saving function. As regards this portable terminal apparatus, when no data communication is executed for a predetermined time period between the portable terminal apparatus and an access point which is wirelessly connected to the portable terminal apparatus, power supply to a transmission/reception unit in the portable terminal apparatus is halted.

The power-saving technique disclosed in Jpn. Pat. Appln. KOKAI Publication No. 2006-005577, however, is applied only after wireless connection is established between the portable terminal apparatus and the access point. No consideration is given to power saving during a time period prior to the establishment of the wireless connection.

In the wireless LAN standard, an active state called “Awake state” and a sleep state called “Doze state” are defined as states of the wireless communication module. The sleep state is a state in which the wireless communication module executes neither transmission nor reception of a wireless signal. The power consumed in the sleep state by the wireless communication module is much less than the power consumed in the active state by the wireless communication module.

In order to execute wireless communication with an access point, the portable terminal apparatus is required to detect an access point which is present around the portable terminal apparatus. Thus, in normal cases, during the time period prior to establishment of wireless communication with an access point, the wireless communication module is kept in the Awake state, and does not transition to the sleep state, in preparation for, e.g. reception of a beacon signal from the access point. Consequently, the wireless communication module keeps on consuming power during the time period until the wireless communication with the access point is established.

In order to increase the battery-powered operation time of the electronic apparatus with the wireless communication function, it is necessary, therefore, to realize a novel function for reducing power consumption of the wireless communication module during the time period prior to the establishment of wireless communication with a wireless device such as an access point.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an example of the external appearance of an electronic apparatus according to an embodiment of the invention;

FIG. 2 is an exemplary block diagram showing the system configuration of the electronic apparatus shown in FIG. 1;

FIG. 3 is an exemplary block diagram showing the structures of an application program and a wireless LAN driver in the electronic apparatus shown in FIG. 1;

FIG. 4 is an exemplary view showing an example of an operation screen which is used in the electronic apparatus shown in FIG. 1;

FIG. 5 is an exemplary diagram showing an example of the control procedure of a scan process which is executed by the electronic apparatus shown in FIG. 1;

FIG. 6 is an exemplary flowchart illustrating an example of the procedure of a scan control process which is executed by the wireless LAN driver in the electronic apparatus shown in FIG. 1;

FIG. 7 is an exemplary flowchart illustrating an example of the procedure of a process for varying the scan time of a specified channel in the electronic apparatus shown in FIG. 1;

FIG. 8 is an exemplary flowchart illustrating the procedure of a scan process which is executed by a wireless LAN module provided in the electronic apparatus shown in FIG. 1;

FIG. 9 is an exemplary diagram showing an example of scan times of communication channels 1 to 13 which are used in the electronic apparatus shown in FIG. 1;

FIG. 10 is an exemplary flowchart illustrating another example of the procedure of the process for varying the scan time of a specified channel in the electronic apparatus shown in FIG. 1;

FIG. 11 shows an example of a table which is used in the electronic apparatus shown in FIG. 1;

FIG. 12 illustrates another example of the control procedure of the scan process which is executed by the electronic apparatus shown in FIG. 1; and

FIG. 13 is an exemplary flowchart illustrating another example of the procedure of the scan control process which is executed by the wireless LAN driver in the electronic apparatus shown in FIG. 1.

### DETAILED DESCRIPTION

Various embodiments according to the invention will be described hereinafter with reference to the accompanying drawings. In general, according to one embodiment of the invention, an electronic apparatus executes wireless communication with use of any one of a plurality of wireless communication channels. The electronic apparatus includes a wireless communication module, a scan process control unit, and a device list sending unit. The wireless communication module is configured to transition between an active state in which the wireless communication is executable and a sleep state in which power consumption of the wireless communication module is less than in the active state. The scan process control unit transitions, when an application program that is executed by the electronic apparatus outputs a wireless device detection request in response to a user's request, the wireless communication module from the sleep state to the active state, and causes the wireless communication module to execute a scan process for detecting wireless devices, which are present around the wireless communication module, with respect to each of the plurality of wireless communication channels, and transitions, when the scan process for all the plurality of wireless communication channels is terminated, the wireless communication module from the active state to the sleep state. The device list sending unit sends to the application program a device list indicating wireless devices detected by the scan process for the plurality of wireless communication channels.

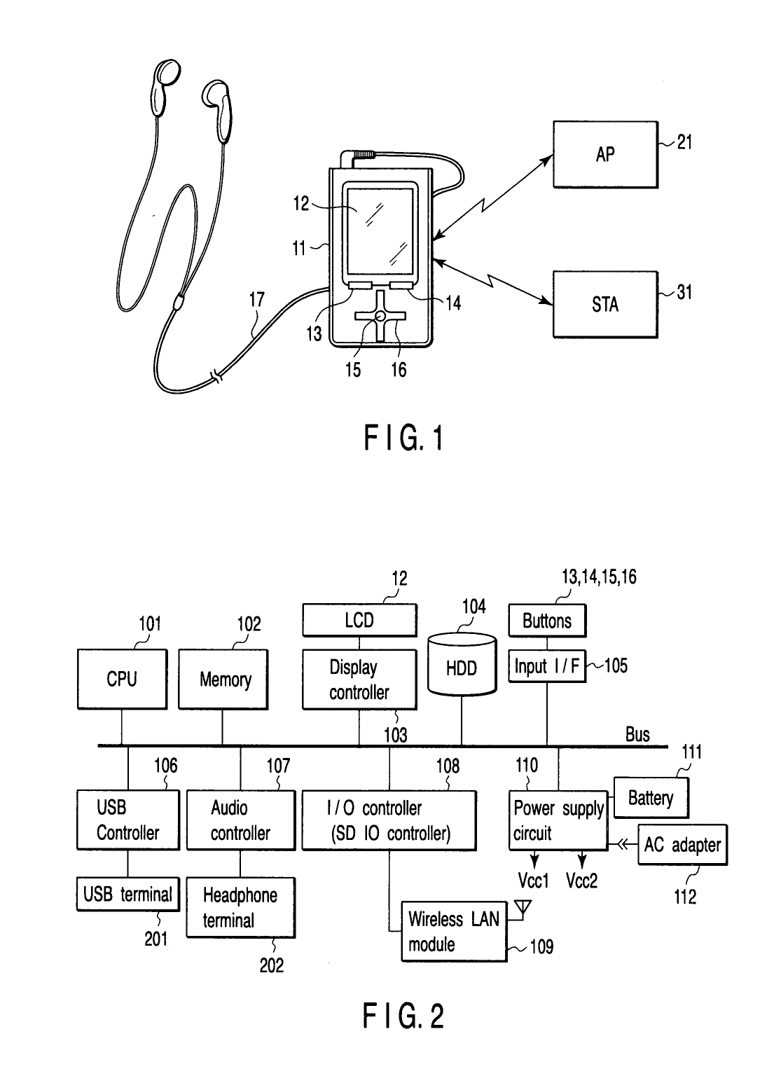

To begin with, referring to FIG. 1, the structure of an electronic apparatus according to the embodiment of the invention is described.

This electronic apparatus is a portable apparatus such as a personal computer, a PDA or an AV (audio-video) player, and is configured to be capable of being driven by a built-in battery. In the description below, it is assumed that the electronic apparatus is realized as an AV player 11 for reproducing audio data and video data.

An LCD 12 serving as a display device and various operation buttons (back button 13, start button 14, OK button 15 and plus button 16) serving as input devices are provided on the surface of the main body of the AV player 11. Headphones 17 are connected to a headphone terminal that is provided, for example, on a top surface of the main body of the AV player 11.

The AV player 11 has a wireless communication function, such as Wireless LAN, which is specified by the IEEE 802.11b/g standard. The AV player 11 can execute wireless communication with various wireless devices (access point (AP) 21, station (STA) 31) which support the IEEE 802.11b/g standard. For example, the AV player 11 establishes wireless connection to the access point (AP) 21, thus being able to access a server on the Internet via the access point (AP) 21 and to download audio data, video data, etc. from the server. The station 31 is composed of, for instance, a personal computer, or another AV player having the same wireless communication function as the AV player 11. The AV player 11 establishes wireless communication with the station (STA) 31, thus being able to exchange, e.g. audio data, video data, etc. with the station (STA) 31.

Next, referring to FIG. 2, the system configuration of the AV player 11 is described.

As shown in FIG. 2, the AV player 11 includes a CPU 10, a memory 102, a display controller 103, a hard disk drive (HDD) 104, an input interface unit 105, a universal serial bus (USB) controller 106, an audio controller 107, an I/O controller 108, a wireless LAN module 109, a power supply circuit 110 and a battery 111.

The CPU 101 is a processor for controlling the operation of the AV player 11, and the CPU 101 executes various programs (an operating system, an application program, a wireless LAN driver, etc.) which are loaded in the memory 102. The application program is a program for, for example, reproducing audio data and video data and executing wireless communication. The wireless LAN driver is a driver program for controlling the wireless LAN module 109 in accordance with a request from the application program.

The display controller 103 controls the LCD 12 and displays, for example, various operation menus and images corresponding to video data reproduced by the application program, on the display screen of the LCD 12. The HDD 104 functions as a storage device for storing various data such as audio data and video data. The USB controller 106 is connected to a USB terminal 201 which is provided on the main body of the AV player 11, and executes communication with various other devices connected to the USB terminal 201. The audio controller 107 is a sound source device which generates a sound signal corresponding to audio data that is reproduced by the application program, and outputs the generated sound signal to a headphone terminal 202. The I/O controller 108 is a controller for executing interface with the wireless LAN module 109, and is composed of, for instance, an SD IO host controller for controlling an SD IO card. In this case, the I/O controller 108 and the wireless LAN module 109 are connected via an SD IO bus.

The wireless LAN module 109 is a wireless communication module (wireless communication device) which executes wireless communication according to, e.g. the IEEE 802.11b/g standard. In the IEEE 802.11b/g standard, 13 wireless communication channels, that is, channel 1 to channel 13, which have different carrier frequencies, are defined, and the wireless LAN module 109 can execute wireless communication by using an arbitrary one of the 13 wireless communication channels.

In general terms, the wireless LAN module 109 has two states. One is an active state called “Awake state” and the other is a sleep state called “Doze state”. The state of the wireless LAN module 109 is set in one of the active state and sleep state. The wireless LAN module 109 is configured to transition between the active state and the sleep state. The sleep state is a power-saving state in which the wireless LAN module 109 executes neither transmission nor reception of a wireless signal. The power consumed in the sleep state by the wireless LAN module 109 is much less than the power consumed in the active state by the wireless LAN module 109. The active state, or Awake state, is a state in which the wireless LAN module 109 is capable of executing wireless communication. In the active state, or Awake state, the wireless LAN module 109 can receive a wireless signal and can transmit a wireless signal in response to a transmission request from the wireless LAN driver.

In some cases, the Awake state is also called “receivable state” (including both a standby state and a state in which a wireless signal is actually received), and the state in which a wireless signal is actually transmitted is also called “transmission state”. If the wireless LAN module 109 in the Awake state receives a transmission request from the wireless LAN driver, the wireless LAN module 109 automatically transitions to the transmission state and transmits a wireless signal. Upon completion of the transmission of the wireless signal, the wireless LAN module 109 automatically returns to the Awake state.

The power supply circuit 110 supplies operational power to the respective components of the AV player 11, using power from a battery 111 which is provided within the main body of the AV player 11 or power supplied from an external AC adapter 112.

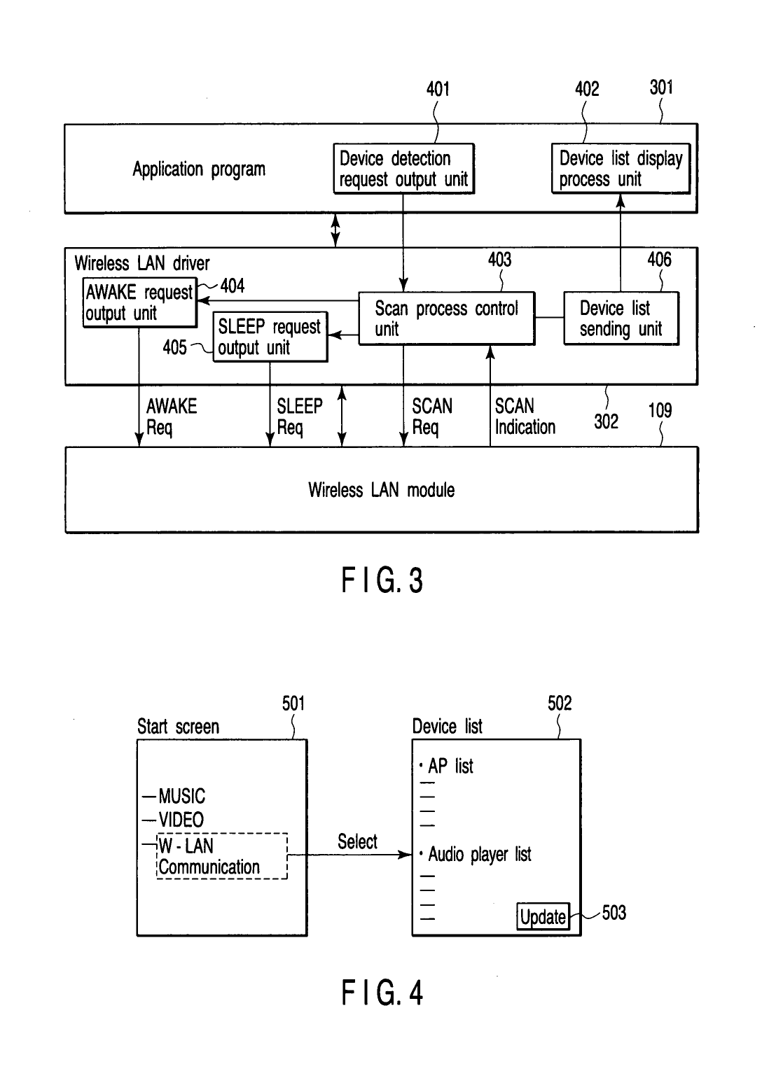

Next, referring to FIG. 3, a description is given of the power-saving function for reducing the power consumption of the wireless LAN module 109. FIG. 3 shows the relationship between the application program 301, wireless LAN driver 302 and wireless LAN module 109.

The power-saving function of the present embodiment reduces the power consumption of the wireless LAN module 109 during a time period prior to establishment of wireless connection between the wireless device (access point (AP) 21 or station (STA) 31) and the wireless LAN module 109. The power-saving function is realized by the wireless LAN driver 302.

Specifically, during the time period prior to establishment of wireless connection to the wireless device, the wireless LAN driver 302 keeps the wireless LAN module 109 not in the AWAKE state, but in the SLEEP state. Only when detection of a wireless device has been requested by the user, that is, only when the application program 301 has output a wireless device detection request in response to a request from the user, the wireless LAN driver 302 transitions the wireless LAN module 109 from the SLEEP state to the AWAKE state and causes the wireless LAN module 109 to execute a scan process. The scan process is a process of detecting a wireless device which is present around the wireless LAN module 109, that is, around the AV player 11. In the Wireless LAN, as described above, 13 wireless communication channels, i.e. channel 1 to channel 13, are defined. Thus, the scan process is executed for each of the 13 communication channels. When the scan process for all the 13 communication channels is completed, the wireless LAN driver 302 transitions the wireless LAN module 109 to the SLEEP state.

As has been described above, the wireless LAN module 109 is kept in the SLEEP state until the wireless connection between the wireless LAN module 109 and the wireless device is established. The wireless LAN module 109 is temporarily transitioned from the SLEEP state to the AWAKE state only when the user has requested detection of the wireless device. Then, the wireless LAN module 109 executes the scan process for all the 13 communication channels. If the execution of the scan process for all the 13 communication channels is completed, the wireless LAN module 109 transitions to the SLEEP state from the AWAKE state once again. Therefore, the time period in which the wireless LAN module 109 is set in the AWAKE state can be restricted, and it becomes possible to reduce the power consumption of the wireless LAN module 109 during the time period prior to establishment of wireless connection between the wireless device and the wireless LAN module 109.

Next, the functional structures of the application program 301 and wireless LAN driver 302 are described.

The application program 301 is a program for transferring various content data (audio data, video data, etc.) to/from the wireless device by making use of wireless communication. The application program 301 receives various operation requests from the user in connection with the wireless communication function by using a GUI (graphical user interface), and executes communication with the wireless LAN driver 302 in accordance with the operation requests. The application program 301 includes a device detection request output unit 401 and a device list display process unit 402. The device detection request output unit 401 and device list display process unit 402 are, for example, software modules which are executed by the CPU 101.

In response to the user's request for wireless device detection, the device detection request output unit 401 sends to the wireless LAN driver 302 a wireless device detection request which instructs execution of the scan process. The device list display process unit 402 displays, on the display screen of the LCD 12, a device list of wireless devices which have been detected by the scan process that is executed by the wireless LAN module 109.

The wireless LAN driver 302 is a program for controlling the wireless LAN module 109 in accordance with the request from the application program 301. In order to realize the above-described power-saving function, the wireless LAN driver 302 includes a scan process control unit 403, an AWAKE request output unit 404, a SLEEP request output unit 405 and a device list sending unit 406. The scan process control unit 403, AWAKE request output unit 404, SLEEP request output unit 405 and device list sending unit 406 are, for example, software modules which are executed by the CPU 101.

In the case where the application program 301 has output the wireless device detection request in response to the user's request, the scan process control unit 403 uses the AWAKE request output unit 404 to transition the wireless LAN module 109 from the SLEEP state to AWAKE state, and sends a scan request (SCAN Req) to the wireless LAN module 109, thereby causing the wireless LAN module 109 to execute the scan process for each of the wireless communication channels 1 to 13. If the scan process control unit 403 receives a notice (SCAN Indication), which indicates the completion of the scan process for all the wireless communication channels 1 to 13, from the wireless LAN module 109, the scan process control unit 403 uses the SLEEP request output unit 405 to transition the wireless LAN module 109 from the AWAKE state to SLEEP state.

Responding to the request from the scan process control unit 403, the AWAKE request output unit 404 sends to the wireless LAN module 109 an AWAKE request (AWAKE Req) which instructs transition to the AWAKE state. Responding to the request from the scan process control unit 403, the SLEEP request output unit 405 sends to the wireless LAN module 109 a SLEEP request (SLEEP Req) which instructs transition to the SLEEP state.

The device list sending unit 406 sends to the application program 301 a device list indicating wireless devices which have been detected by the scan process.

Upon receiving the AWAKE request (AWAKE Req) from the wireless LAN driver 302, the wireless LAN module 109 transitions from the SLEEP state to AWAKE state. In addition, upon receiving the SLEEP request (SLEEP Req) from the wireless LAN driver 302, the wireless LAN module 109 transitions from the AWAKE state to SLEEP state.

Upon receiving the scan request (SCAN Req) from the wireless LAN driver 302, the wireless LAN module 109 starts the scan process for each of the wireless communication channels 1 to 13. The scan process for each wireless communication channel is executed, for example, by active scan. In the active scan, the wireless LAN module 109 broadcasts a probe request packet (Probe Req), and waits for transmission of a probe response packet (Probe Res) from the wireless device. By receiving the probe response packet (Probe Res), the wireless LAN module 109 can acquire information (e.g. media access control (MAC) address, service set identifier (SSID), type of wireless device, etc.) which identifies the wireless device that has transmitted the probe response packet (Probe Res).

In the present embodiment, in order to minimize the time period in which the wireless LAN module 109 is kept in the AWAKE state prior to establishment of wireless connection to the wireless device, the execution time of the scan process for each wireless communication channel is limited to a preset time (e.g. 200 ms). If a limit time (e.g. 200 ms) has passed since the start of the scan process for a certain communication channel, the wireless LAN module 109 finishes the scan process for the communication channel, regardless of whether the probe response packet has been received, that is, regardless of whether the wireless device has been detected. Then, the wireless LAN module 109 starts the scan process for the next communication channel.

As has been described above, the wireless LAN module 109 executes the scan process for each of the communication channels 1 to 13 while successively changing the to-be-scanned communication channel between the communication channels 1 to 13 in every cycle of the limit time interval. Hence, the scan process for all the wireless communication channels 1 to 13 is basically completed in the time period of (limit time×13). The application program 301 sends a device list acquisition request to the wireless LAN driver 302 after the passage of a specified time (=limit time×13) from the output of the wireless device detection request.

As will be described later with reference to FIG. 7, the execution time of the scan process for a specified communication channel may be set to be longer than the execution time of the scan process for each of the other communication channels. The reason is that in a case where there are a great number of wireless devices which use a specified communication channel, it may be difficult to detect all wireless devices of the specified communication channel within the limited time of the scan process.

Nest, referring to FIG. 4, an example of the operation screen, which is displayed on the display screen of the LCD 12, is described.

If the user presses, for example, the start button 14, the application program 301 displays a start screen 501 on the display screen of the LCD 12. The start screen 501 is a menu screen for prompting the user to select a function to be executed. The start screen 501 displays, for example, three functional items of “MUSIC”, “VIDEO” and “W-LAN Communication”. If the user selects “MUSIC”, the application program 301 displays a list of audio data stored in the HDD 104 on the display screen of the LCD 12. The application program 301 then reproduces audio data which has been selected by the user from the list of audio data. If the user selects “VIDEO”, the application program 301 displays a list of video data stored in the HDD 104 on the display screen of the LCD 12. The application program 301 then reproduces video data which has been selected by the user from the list of video data.

If the user selects “W-LAN Communication”, the application program 301 sends the above-described wireless device detection request to the wireless LAN driver 302, thereby to cause the wireless LAN module 109 to execute the scan process. Then, the application program 301 acquires from the wireless LAN driver 302 the device list of wireless devices which have been detected by the scan process, and displays a device list screen 502 on the display screen of the LCD 12.

The device list screen 502 displays a list of access points (AP) which are present around the AV player 11, and a list of stations which are present around the AV player 11 (e.g. a list of other audio players (AV players) having the same wireless communication function as the AV player 11). In addition, the device list screen 502 includes an “UPDATE” button 503. Also when the “UPDATE” button 503 is pressed by the user, the application program 301 sends the above-described wireless device detection request to the wireless LAN driver 302, thereby to cause the wireless LAN module 109 to execute the scan process. Then, the application program 301 acquires from the wireless LAN driver 302 the device list of wireless devices which have been detected by the scan process, and displays the device list screen 502 on the display screen of the LCD 12.

Further, if the user selects an arbitrary access point or station displayed on the device list screen 502, the process for establishing wireless connection to the selected access point or station is executed under the control of the wireless LAN driver 302.

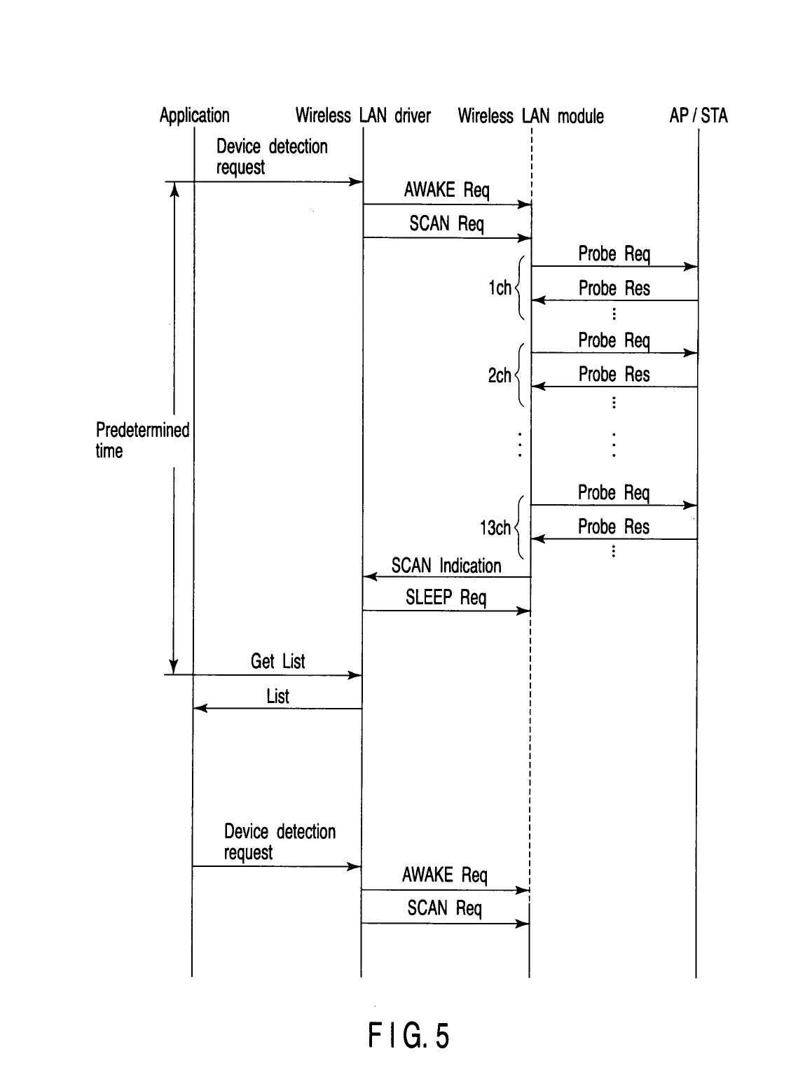

Next, the control procedure of the scan process is described with reference to FIG. 5.

When the AV player 11 is powered on, an initializing process for the wireless LAN module 109 is executed, and then the wireless LAN module 109 is set in the SLEEP state by the wireless LAN driver 302.

When detection of wireless devices has been requested by the user (e.g. when the user has selected “W-LAN Communication” or pressed the “UPDATE” button 503), the application program 301 sends the wireless device detection request to the wireless LAN driver 302.

The wireless LAN driver 302 sends the AWAKE request (AWAKE Req) to the wireless LAN module 109 and transitions the wireless LAN module 109 from the SLEEP state to AWAKE state. In addition, the wireless LAN driver 302 sends the scan request (SCAN Req) to the wireless LAN module 109.

The wireless LAN module 109 successively executes the scan process for the wireless communication channels in the order of wireless communication channels 1 to 13. In the scan process for each wireless communication channel, the wireless LAN module 109 broadcasts the probe request packet (Probe Req) and waits for transmission of the probe response packet (Probe Res), which is a response packet to the probe request packet, from the wireless device.

If the scan process for all the wireless communication channels 1 to 13 is completed, the wireless LAN module 109 sends the SCAN Indication to the wireless LAN driver 302, and informs the wireless LAN driver 302 of the end of the scan process for the wireless communication channels 1 to 13. The wireless LAN driver 302 sends the SLEEP request (SLEEP Req) to the wireless LAN module 109, thereby transitioning the wireless LAN module 109 from the AWAKE state to SLEEP state.

When a predetermined time period (e.g. 200 ms×13, or 200 ms×13+α) has passed since the wireless device detection request was sent, the application program 301 sends a device list acquisition request (Get List) to the wireless LAN driver 302. Responding to the device list acquisition request (Get List), the wireless LAN driver 302 sends to the application program 301 the device list (List) indicating wireless devices which have been detected by the wireless LAN module 109.

The above-described scan process control operation is executed each time the detection of wireless devices is requested by the user. Specifically, prior to establishment of wireless connection to the wireless device, the wireless LAN module 109 transitions from the SLEEP state to AWAKE state only when the detection of wireless devices has been requested by the user. Then, the wireless LAN module 109 executes the scan process for all the wireless communication channels and, after the scan process for all the wireless communication channels is completed, returns to the SLEEP state.

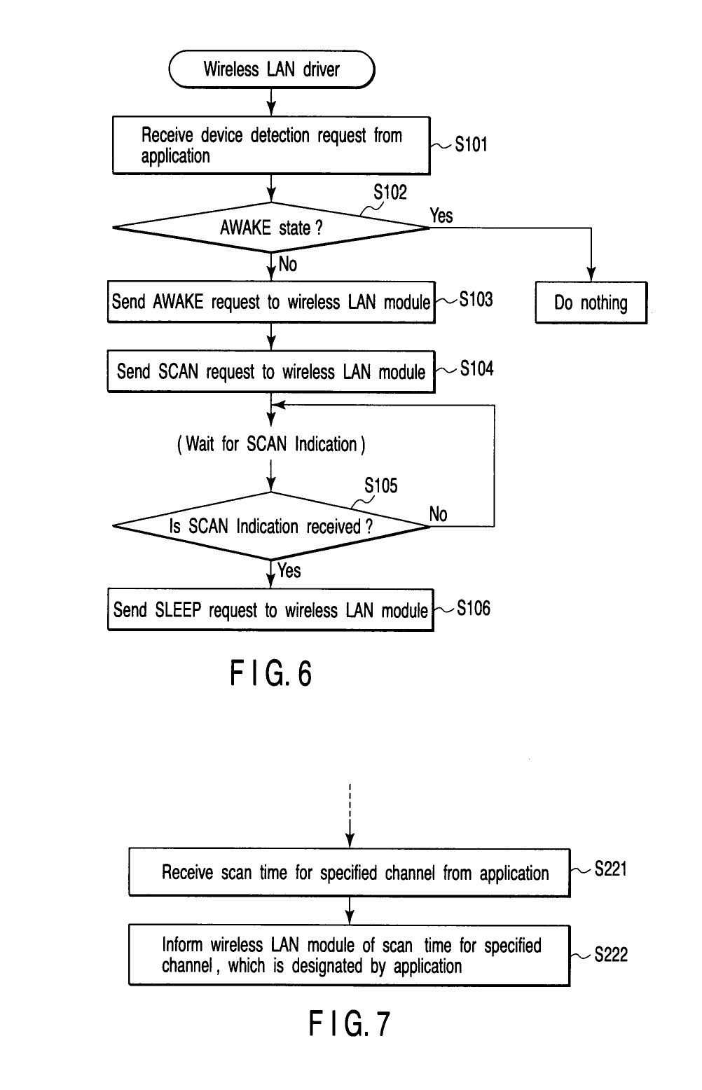

Next, referring to a flow chart of FIG. 6, the procedure of the scan control process, which is executed by the wireless LAN driver 302, is described.

If the wireless LAN driver 302 receives the wireless device detection request from the application program 301 (block S101), the wireless LAN driver 302 determines whether the wireless LAN module 109 is in the AWAKE state or not, that is, whether the wireless LAN module 109 is executing the scan process or not (block S102). If the wireless LAN module 109 is in the AWAKE state, that is, if the wireless device detection request is received while the wireless LAN module 109 is executing the scan process (YES in block S102), the wireless LAN driver 302 does nothing.

On the other hand, if the wireless LAN module 109 is in the SLEEP state, that is, if the scan process is not being executed (NO in block S102), the wireless LAN driver 302 sends the AWAKE request (AWAKE Req) to the wireless LAN module 109 (block S103). In addition, the wireless LAN driver 302 sends the scan request (SCAN Req) to the wireless LAN module 109, and causes the wireless LAN module 109 to start the scan process (block S104). Then, the wireless LAN driver 302 waits for transmission of the SCAN Indication from the wireless LAN module 109. If the wireless LAN driver 302 receives the SCAN Indication from the wireless LAN module 109 (YES in block S105), the wireless LAN driver 302 acquires from the wireless LAN module 109 the information (scan list) indicating the list of wireless devices which have been detected by the scan process, and then sends the SLEEP request (SLEEP Req) to the wireless LAN module 109, thus transitioning the wireless LAN module 109 to the SLEEP state (block S106).

As has been described above, in the present embodiment, during the time period prior to establishment of wireless connection between the wireless device and the wireless LAN module 109, the wireless LAN module 109 transitions from the SLEEP state to AWAKE state only when the detection of wireless devices has been requested by the user. If the scan process is completed, the wireless LAN module 109 returns to the SLEEP state.

Next, a description is given of the process of varying the execution time (scan time) of the scan process for a specified wireless communication channel.

As described above, in the case where there are a great number of access points and stations which belong to one specified wireless communication channel, there may be a case in which all wireless devices belonging to this communication channel cannot be detected within a preset specified scan time. In addition, in the scan control in which the scan process is executed only when the detection of wireless devices has been requested by the user, as in the present embodiment, it is preferable to detect, in a single scan process, as many as possible wireless devices which are present around the AV player 11.

Thus, in the present embodiment, a process is executed for changing the scan time for a specified wireless communication channel to a time that is designated by the application program 301, or a process is executed for changing the scan time for a specified wireless communication channel in accordance with the number of wireless devices, which have been detected by the previous scan process for the specified wireless communication channel.

A flow chart of FIG. 7 illustrates the procedure of the former process mentioned above.

If the wireless LAN driver 302 receives information which designates the scan time (i.e. execution time of the scan process) for a specified channel (e.g. wireless communication channel 11) from the application program 301 (block S221), the wireless LAN driver 302 informs the wireless LAN module 109 of the scan time for the specified channel that is designated by the application program 301, and causes the wireless LAN module 109 to execute the scan process for the specified channel for a longer time than the scan process for each of the other channels (block S222).

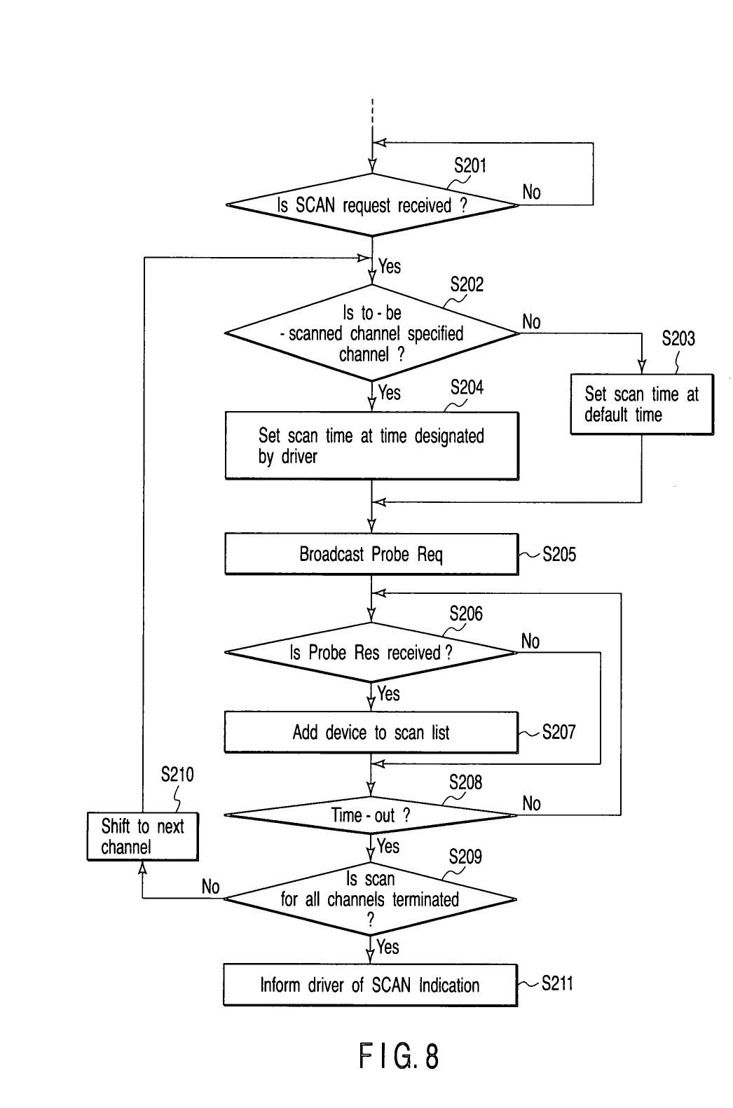

A flow chart of FIG. 8 illustrates the procedure of the scan process which is executed by the wireless LAN module 109.

If the wireless LAN module 109 receives the scan request (SCAN Req) from the wireless LAN driver 302 (YES in block S201), the wireless LAN module 109 executes the scan process while successively changing the wireless communication channel that is the object of scan. In this case, the wireless LAN module 109 first determines whether the current to-be-scanned wireless communication channel is a specified wireless communication channel for which the scan time is designated (block S202). If the to-be-scanned wireless communication channel is not the specified wireless communication channel (NO in block S202), the wireless LAN module 109 sets the scan time (i.e. execution time of the scan process) at a default time (e.g. 200 ms) (block S203). On the other hand, if the to-be-scanned wireless communication channel is the specified wireless communication channel (YES in block S202), the wireless LAN module 109 sets the scan time (i.e. execution time of the scan process) at a time (e.g. 500 ms) that is designated via the wireless LAN driver 302 (block S204).

Subsequently, the wireless LAN module 109 broadcasts the probe request packet (Probe Req) (block S205). Upon receiving the probe response packet (Probe Res) (YES in block S206), the wireless LAN module 109 adds the wireless device information, which is included in the received probe response packet, to the scan list (block S207). Until the preset scan time is reached, the process of blocks S206 and S207 is repeated.

When time-out is determined, that is, when the preset scan time is reached (YES in block S208), the wireless LAN module 109 determines whether the scan process for all the communication channels is completed (block S209). If there remains a communication channel for which the scan process has not yet been executed (NO in block S209), the wireless LAN module 109 executes a process for shifting the scan process to the next communication channel, that is, a process for changing the to-be-scanned communication channel to the next communication channel (block S210), and the wireless LAN module 109 advances to the process of block S202.

On the other hand, if the scan process for all the communication channels is completed (YES in block S209), the wireless LAN module 109 sends the SCAN Indication to the wireless LAN driver 302 (block S211).

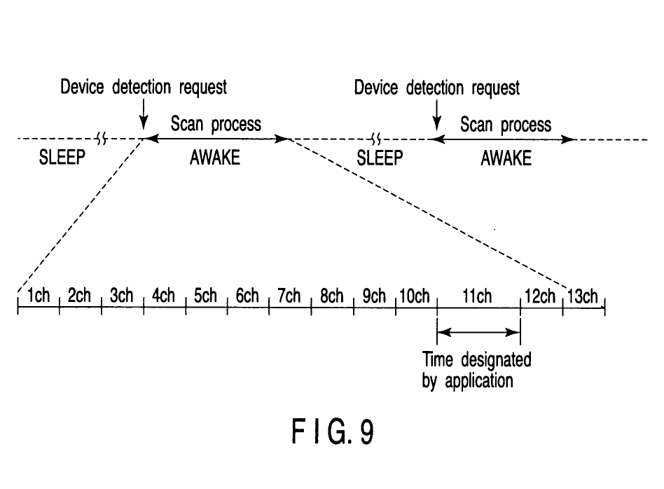

FIG. 9 shows an example of scan times of communication channels 1 to 13.

In FIG. 9, it is assumed that the scan time for the communication channel 11 is designated by the application program 301, and the designated scan time is longer than the default scan time. In this case, the scan process for the communication channel 11 is executed for a longer time than the scan process for each of the other communication channels. Thereby, even in the case where there are many wireless devices in the communication channel 11, the possibility that all the wireless devices can be detected is increased.

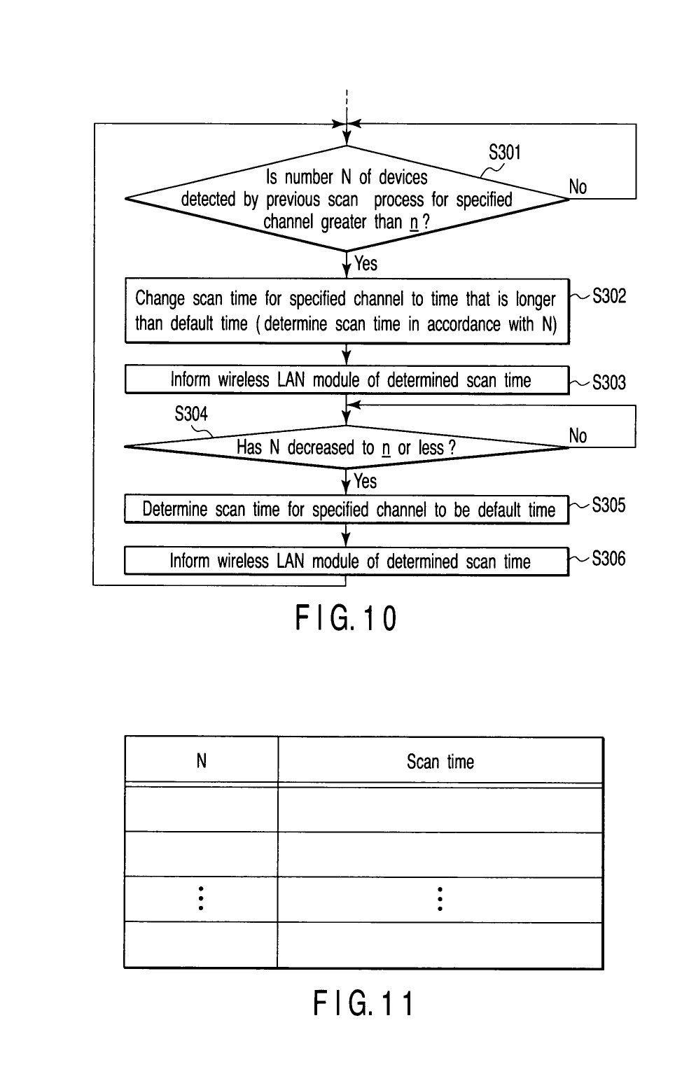

Next, referring to a flow chart of FIG. 10, a description is given of the procedure of the process for dynamically varying the scan time in accordance with the number of wireless devices which have been detected in the previous scan process.

The wireless LAN driver 302 determines whether the number N of wireless devices, which have been detected in the previous scan process for a specified channel, is greater than n (block S301). If the number N of wireless devices, which have been detected in the previous scan process for the specified channel, is greater than n (YES in block S301), the wireless LAN driver 302 determines a new scan time for the specified channel in accordance with the value of N, thereby to change the scan time for the specified channel to a time longer than the default time (block S302). In the process of block S302, a table shown in FIG. 11, for example, can be used. In this table, scan times are defined in association with values of N. By referring to the table, the wireless LAN driver 302 can easily determine the scan time corresponding to the value of N.

The wireless LAN driver 302 informs the wireless LAN module 109 of the determined scan time for the specified channel, thereby to cause the wireless LAN module 109 to execute the scan process for the specified channel for a longer time than the scan process for each of the other channels (block S303).

If the number N of wireless devices belonging to the specified channel has decreased to n or less after the scan time for the specified channel was changed to the time longer than the default time (YES in block S304), the wireless LAN driver 302 determines the scan time for the specified channel to be the default time and informs the wireless LAN module 109 of the determined time (block S305, S306).

As has been described above, in the present embodiment, the scan time for the specified channel is dynamically varied in accordance with the number of wireless devices which have been detected in the previous scan process for the specified channel. Specifically, if the number N of wireless devices, which have been detected in the previous scan process for the specified channel, is greater than n, the scan time for the specified channel is increased. Thereby, all the wireless devices belonging to the specified channel can be detected.

In the case where the scan time is dynamically varied as described above, the application program 301 is unable to understand when the scan process for the channels 1 to 13 to be terminated. It is thus preferable to execute a process for sending a termination notice, which indicates that the scan process for the channels 1 to 13 has been terminated, from the wireless LAN driver 302 to the application program 301. Thereby, the application program 301 can acquire the device list without taking care of the timing of termination of the scan process.

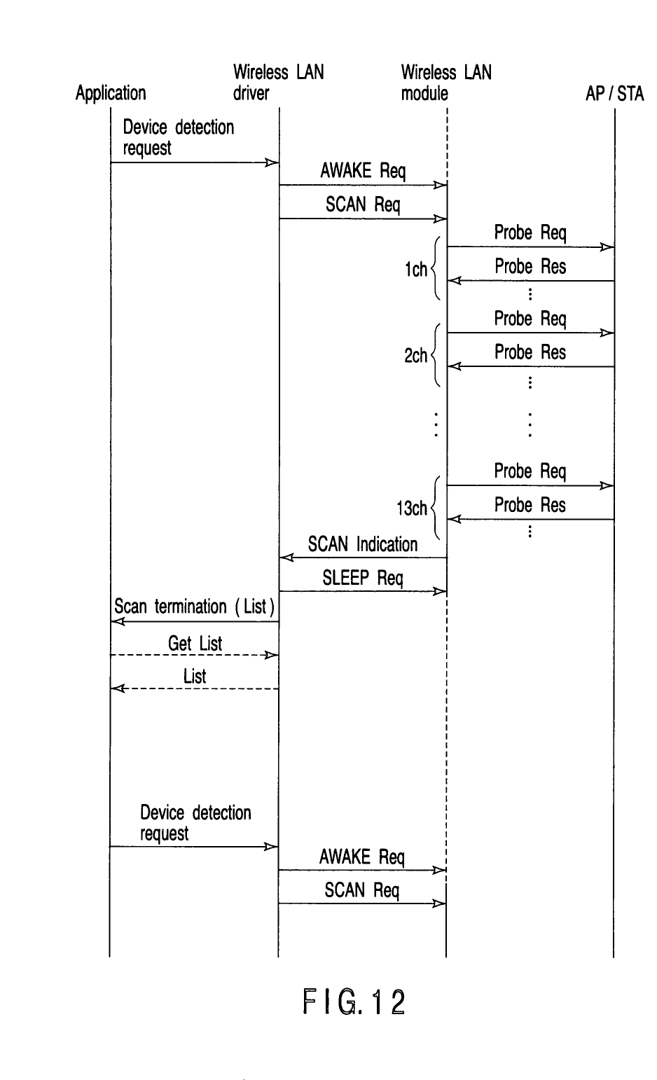

Next, referring to FIG. 12, a description is given of the scan process control procedure including the above-described termination notice process.

When detection of wireless devices has been requested by the user (e.g. when the user has selected “W-LAN Communication” or pressed the “UPDATE” button 503), the application program 301 sends the wireless device detection request to the wireless LAN driver 302.

The wireless LAN driver 302 sends the AWAKE request (AWAKE Req) to the wireless LAN module 109 and transitions the wireless LAN module 109 from the SLEEP state to AWAKE state. In addition, the wireless LAN driver 302 sends the scan request (SCAN Req) to the wireless LAN module 109.

The wireless LAN module 109 successively executes the scan process for the wireless communication channels in the order of wireless communication channels 1 to 13. In the scan process for each wireless communication channel, the wireless LAN module 109 broadcasts the probe request packet (Probe Req) and waits for transmission of the probe response packet (Probe Res), which is a response packet to the probe request packet, from the wireless device.

If the scan process for all the wireless communication channels 1 to 13 is completed, the wireless LAN module 109 sends the SCAN Indication to the wireless LAN driver 302, and informs the wireless LAN driver 302 of the termination of the scan process for the wireless communication channels 1 to 13. The wireless LAN driver 302 sends the SLEEP request (SLEEP Req) to the wireless LAN module 109, thereby transitioning the wireless LAN module 109 from the AWAKE state to SLEEP state. In addition, the wireless LAN driver 302 sends to the application program 301 the termination notice which indicates that the scan process for all the wireless communication channels 1 to 13 is terminated.

Responding to the termination notice, the application program 301 sends the device list acquisition request (Get List) to the wireless LAN driver 302. Responding to the device list acquisition request (Get List), the wireless LAN driver 302 sends to the application program 301 the device list (List) indicating wireless devices which have been detected by the wireless LAN module 109.

In the meantime, the wireless LAN driver 302 may send to the application program 301 the termination notice including the device list (list).

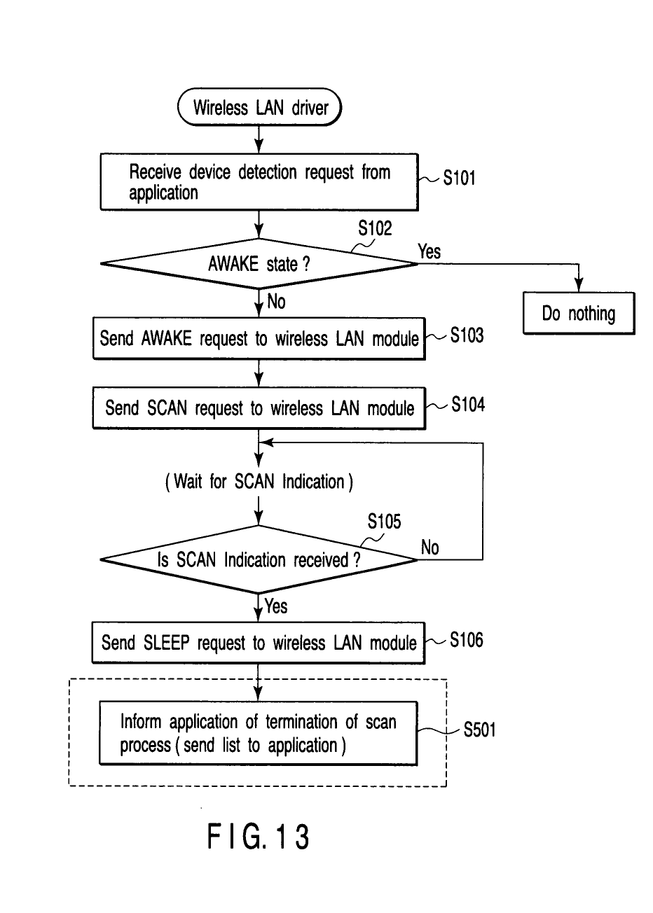

Next, referring to a flow chart of FIG. 13, a description is given of the procedure of the scan control process which is executed by the wireless LAN driver 302. This procedure includes the above-described termination notice process.

The process of blocks S101 to S106 in FIG. 13 is the same as the process of blocks S101 to S106, which has been described with reference to FIG. 6. After the scan process for the wireless communication channels 1 to 13 is terminated, the wireless LAN driver 302 sends the termination notice to the application program 301 after sending the SLEEP request (SLEEP Req) to the wireless LAN module 109 (block S501).

The entire procedure of the scan control process according to the present embodiment can be executed by software. Thus, the same advantageous effects as with the present embodiment can easily be obtained simply by installing a program, which executes this procedure, into a computer including a wireless LAN module through a computer-readable storage medium.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus which executes wireless communication with use of any one of a plurality of wireless communication channels, comprising:
a wireless communication module configured to transition between an active state in which the wireless communication is executable and a sleep state in which power consumption of the wireless communication module is less than in the active state;
a scan process control unit which transitions, when an application program that is executed by the electronic apparatus outputs a wireless device detection request in response to a user's request, the wireless communication module from the sleep state to the active state, and causes the wireless communication module to execute a scan process for detecting wireless devices, which are present around the wireless communication module, with respect to each of the plurality of wireless communication channels, and transitions, when the scan process for all the plurality of wireless communication channels is terminated, the wireless communication module from the active state to the sleep state; and
a device list sending unit which sends to the application program a device list indicating wireless devices detected by the scan process for the plurality of wireless communication channels.

2. The electronic apparatus according to claim 1, wherein an execution time of the scan process for each of the plurality of wireless communication channels is limited to a predetermined time, and the wireless communication module successively changes the communication channel, which is to be scanned, between the plurality of communication channels in every cycle of the predetermined time, and
the device list sending unit sends the device list to the application program in response to a device list acquisition request which is sent from the application program after passage of a specified time from the output of the wireless device detection request.

3. The electronic apparatus according to claim 1, wherein the scan process control unit informs the wireless communication module of an execution time of the scan process for a specified wireless communication channel of the plurality of wireless communication channels, the execution time of the scan process for a specified wireless communication channel being designated by the application program, and causes the wireless communication module to execute the scan process for the specified wireless communication channel for a longer time than the scan process for each of the other wireless communication channels.

4. The electronic apparatus according to claim 1, wherein the scan process control unit determines, in a case where a number of wireless devices detected by a previous scan process for a specified wireless communication channel of the plurality of wireless communication channels is greater than a predetermined number, an execution time of the scan process for the specified wireless communication channel in accordance with the number of the detected wireless devices, informs the wireless communication module of the determined execution time of the scan process for the specified wireless communication channel, and causes the wireless communication module to execute the scan process for the specified wireless communication channel for a longer time than the scan process for each of the other wireless communication channels.

5. The electronic apparatus according to claim 4, wherein the device list sending unit sends, when the scan process for all the plurality of wireless communication channels is terminated, a termination notice, which indicates that the scan process for all the plurality of wireless communication channels is terminated, to the application program.

6. A wireless communication control method which controls a wireless communication module which is provided in an electronic apparatus that executes wireless communication with use of any one of a plurality of wireless communication channels, the wireless communication module being configured to transition between an active state in which the wireless communication is executable and a sleep state in which power consumption of the wireless communication module is less than in the active state, the method comprising:
transitioning, when an application program which is executed by the electronic apparatus outputs a wireless device detection request in response to a user's request, the wireless communication module from the sleep state to the active state, and causing the wireless communication module to execute a scan process for detecting wireless devices, which are present around the wireless communication module, with respect to each of the plurality of wireless communication channels;
transitioning, when the scan process for all the plurality of wireless communication channels is terminated, the wireless communication module from the active state to the sleep state; and
sending to the application program a device list indicating wireless devices detected by the scan process for the plurality of wireless communication channels.

7. The wireless communication control method according to claim 6, wherein an execution time of the scan process for each of the plurality of wireless communication channels is limited to a predetermined time, and the wireless communication module successively changes the communication channel, which is to be scanned, between the plurality of communication channels in every cycle of the predetermined time, and
said sending the device list to the application program includes sending the device list to the application program in response to a device list acquisition request which is sent from the application program after passage of a specified time from the output of the wireless device detection request.

8. The wireless communication control method according to claim 6, further comprising informing the wireless communication module of an execution time of the scan process for a specified wireless communication channel of the plurality of wireless communication channels, the execution time of the scan process for the specified wireless communication channel being designated by the application program, and causing the wireless communication module to execute the scan process for the specified wireless communication channel for a longer time than the scan process for each of the other wireless communication channels.

9. The wireless communication control method according to claim 6, further comprising:
determining, in a case where a number of wireless devices detected by a previous scan process for a specified wireless communication channel of the plurality of wireless communication channels is greater than a predetermined number, an execution time of the scan process for the specified wireless communication channel in accordance with the number of the detected wireless devices; and
informing the wireless communication module of the determined execution time of the scan process for the specified wireless communication channel, and causing the wireless communication module to execute the scan process for the specified wireless communication channel for a longer time than the scan process for each of the other wireless communication channels.

10. The wireless communication control method according to claim 9, wherein said sending the device list to the application program includes sending, when the scan process for all the plurality of wireless communication channels is terminated, a termination notice, which indicates that the scan process for all the plurality of wireless communication channels is terminated, to the application program.
